(19) United States
(12) Patent Application Publication
(10) Pub. No.: US 2011/0161822 A1
(43) Pub. Date: Jun. 30, 2011

(54) METHOD AND SYSTEM FOR CONNECTION MANAGEMENT AND RESOURCE SHARING

(75) Inventors: Eil Beron Meghdies Vardeh, Mississauga (CA); Nader Newman, Brampton (CA)

(73) Assignee: PSION TEKLOGIX INC., Mississauga (CA)

(21) Appl. No.: 12/650,032

(22) Filed: Dec. 30, 2009

(51) Int. Cl. G06F 13/10; G06F 3/01

(52) U.S. Cl. 715/733; 710/8

(57) ABSTRACT

A method and system for connection management and resource sharing is provided. The method includes; initial setting up each resource dependent device, including: classifying a resource dependent device in group and assigning a resource associated with a limited resource device to the group; and selecting one resource dependent device from each group to be actively connected to the corresponding resource of the limited resource device. The system includes: an initial setting up module for classifying a resource dependent device in group and assigning a resource available in a limited resource device to the group; and a selector for selecting a single resource dependent device from each group to be actively connected to the corresponding resource of the limited resource device. The method includes: selecting a group from a list of groups, each associating with one or more resource dependent devices connectable to a limited resource device and associating with a single resource available in the limited resource device; and selecting a single resource dependent device from the selected group to actively connect the selected single resource dependent device to the corresponding single resource of the limited resource device. The system includes: a first selecting module for selecting a group from a list of groups, each associating with one or more resource dependent devices connectable to a limited resource device and associating with a single resource available in the limited resource device; and a second selecting module for selecting a single resource dependent device from the selected group to actively connect the selected single resource dependent device to the corresponding single resource of the limited resource device.

### FIELD OF INVENTION

The present invention relates to computing devices, more specifically to a system and method for connecting a plurality of devices and sharing a resource with the devices.

### BACKGROUND OF THE INVENTION

Computer devices, such as handheld devices (e.g., PDAs, scanners, RFID readers/writers, image scanners), have been widely used in various applications. To expand their functionalities, the handheld devices are generally configured to communicate with external devices via communication ports (COMs).

However, the computer devices typically have a limited number of physical serial COM ports, and thus it potentially limits computational resource. Some improvements have been made; however they cannot connect a wide variety of devices in an efficient and user-friendly manner.

### SUMMARY OF THE INVENTION

It is an object of the invention to provide a method and system that obviates or mitigates at least one of the disadvantages of existing systems.

According to one embodiment in the disclosure there is provided a method of sharing a resource with a plurality of resource dependent devices, which includes: initial setting up each resource dependent device, including: classifying a resource dependent device in group and assigning a resource associated with a limited resource device to the group; and selecting one resource dependent device from each group to be actively connected to the corresponding resource of the limited resource device.

According to one embodiment in the disclosure there is provided a system for sharing a resource with a plurality of resource dependent devices, which includes: an initial setting up module for classifying a resource dependent device in group and assigning a resource available in a limited resource device to the group; and a selector for selecting a single resource dependent device from each group to be actively connected to the corresponding resource of the limited resource device.

According to one embodiment in the disclosure there is provided a method of sharing a resource with a plurality of resource dependent devices, which includes: selecting a group from a list of groups, each associating with one or more resource dependent devices connectable to a limited resource device and associating with a single resource available in the limited resource device; and selecting a single resource dependent device from the selected group to actively connect the selected single resource dependent device to the corresponding single resource of the limited resource device.

According to one embodiment in the disclosure there is provided a system for sharing a resource with a plurality of resource dependent devices, which includes: a first selecting module for selecting a group from a list of groups, each associating with one or more resource dependent devices connectable to a limited resource device and associating with a single resource available in the limited resource device; and a second selecting module for selecting a single resource dependent device from the selected group to actively connect the selected single resource dependent device to the corresponding single resource of the limited resource device.

### BRIEF DESCRIPTION OF THE DRAWINGS

These and other features of the invention will become more apparent from the following description in which reference is made to the appended drawings wherein:

FIG. 1 is a block diagram illustrating one example of a system having a quick connection system, together with devices;

FIG. 2 is a block diagram illustrating another example of a system having the quick connection system, together with devices;

FIG. 3 is a flow chart illustrating an example of a process for an initial setup operation;

FIG. 4 is a schematic diagram illustrating an example of a user's defined class of device and ports;

FIG. 5 is a flow chart illustrating an example of a process for discovering/scanning procedure;

FIG. 6 is a flow chart illustrating another example of a process for the initial setup operation;

FIG. 7 is a diagram illustrating an exemplary screen display provided by the quick connection system; and

FIG. 8 is a diagram illustrating an exemplary screen display provided by the quick connection system for the initial setup.

### DETAILED DESCRIPTION

One or more currently preferred embodiments have been described by way of example. It will be apparent to persons skilled in the art that a number of variations and modifications can be made without departing from the scope of the invention as defined in the claims.

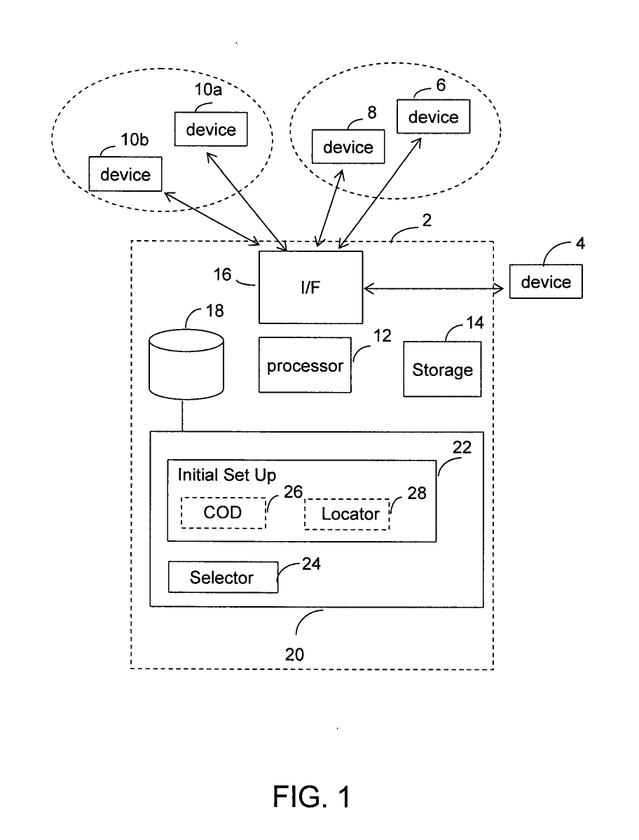

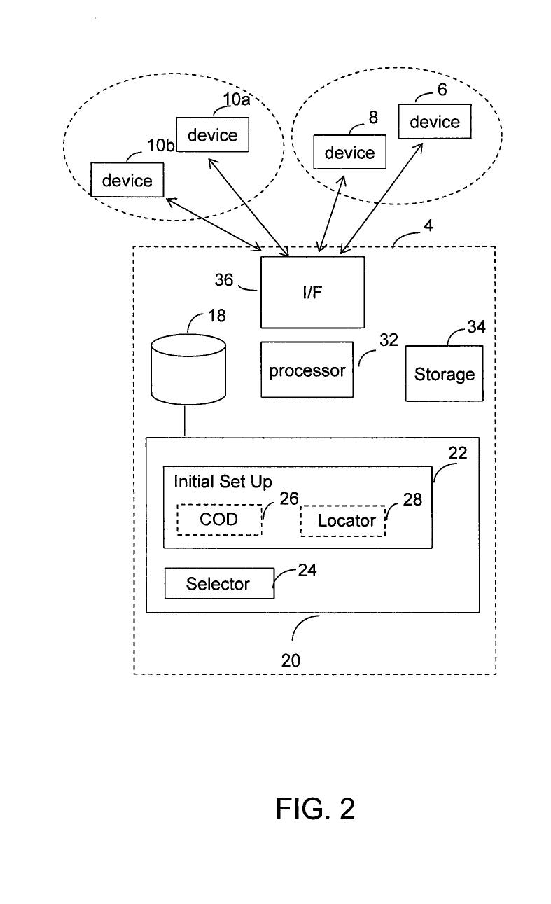

Referring to FIGS. 1-2, there is illustrated an example of a quick connection system 20 for connecting one or more available (connectable) resource-dependent devices to a resource. In FIGS. 1-2, a device 4 is a limited resource device which has a limited number “n” (n; integer) of resources, and devices 6, 8, 10a, and 10b are resource-dependent devices. The quick connection system 20 preserves resources of the device 4 by sharing a single communication port/resource point with multiple resource-dependent devices of the same group. The quick connection system 20 allows only one resource-dependent device from each group to be actively connected to one resource of the device 4 at any given time. The group is classified, for example, by a class of device (COD) or device type. In one example, if multiple printers are in the same COD group, only of those printers is actively used by the device 4 at any given time. The user can change the group configuration as described below. The quick connection system 20 is used with the wired or wireless implementations, such as Ethernet (WLAN) or Bluetooth (PAN).

In the description, “resource” refers to a part of a computer system/network, such as a port, an interface, a memory, a printer, and a scanner. In the description, “resource point” refers to an entity within a system used to access a reference channel, such as how a drive letter is associated to a hard drive or how a DMA point is associated to RAM. In the description, “communication port” refers to a resource directly or indirectly used to establish a communications connection between two computer systems. In the description, “commutation port”, “resource point”, and “port resource” may be used interchangeably.

The device 4 may be a stand alone device. The device 4 may be, for example, but not limited to, a personal computer (PC), a mobile computing device, a cellular telephone, or a personal digital assistant (PDA). The device 4 may use any of a variety of known operating systems, such as Windows Mobile (WM) and Windows Embedded Compact (CE). The resource-dependent devices 6, 8, 10a, and 10b may be, for example, but not limited to, scanners, RFID readers/RFID writers, printers, smart-card readers, image captures, headsets, or combinations thereof.

The devices 4, 6, 8, 10a, and 10b may be Bluetooth devices. The quick connection system 20 may be used to pair multiple resource-dependent Bluetooth devices to a Bluetooth device. A communication port/resource point assigned to a COD may be a serial port, COM or a Bluetooth Serial Port (BSP). The quick connection system 20 does not limit the user to pair a specific type of Bluetooth devices. The device 4 may be a master mode or slave mode Bluetooth device, and the resource-dependent devices 6, 8, 10a, and 10b may be slave mode or master mode Bluetooth devices.

In one example, the quick connection system 20 may be located in a system 2 as shown in FIG. 1. A user operates the system 2 to connect the resource-dependent device(s) to the device 4. The system 2 is, for example, but not limited to, a personal computer (PC). The system 2 includes a database 18 for maintaining and updating data associated with the connection between the device 4 and the devices 6, 8, 10a, and 10b. The system 2 also includes one or more interface modules 16 for communicating with other devices via a wired communication link, a wireless communication link or a combination thereof. The system 2 accesses the devices 4, 6, 8, 10a, and 10b via the interface module(s) 16. The system 2 may include a processor 12 and data storage 14 for operating the processor 12.

Alternatively, the quick connection system 20 may be located in the device 4 as shown in FIG. 2. In FIG. 2, the device 4 includes one or more interface modules 36 for communicating with other devices via a wired communication link, a wireless communication link or a combination thereof, together with the database 18 and the quick connection system 20. The device 4 communicates with the resource-dependent devices via the interface module(s) 36. The device 4 may include a processor 32 and data storage 34 for operating the processor 32, which may correspond to the processor 12 and the data storage 14 of FIG. 1.

In FIGS. 1-2, four resource-dependent devices 6, 8, 10a and 10b are shown. However, the number of the resource-dependent devices is not limited to four and may vary. In the drawings, the database 18 is located separately from the storage 14 (34). However, the database 18 may be integrated with the storage 14 (34). In FIG. 1, one limited resource device 4 is shown. However, the system 2 of FIG. 1 may communicate with more than one limited resource device and preserve resources of each limited resource device. In the drawings, the quick connection system 20 is located separately from the processor 12 (32). However, the quick connection system 20 may be partially or fully integrated with the processor 12 (32). The quick connection system 20 may be implemented on a printed circuit board (or a main logic board) having a processor and a memory.

It will be appreciated by one of ordinary skill in the art that the device 4 and the system 2 may include components not illustrated in the drawings, such as human interfaces (e.g., a display, a keyboard/keypad, a mouse) and audio devices. The quick connection system 20 may be installed into the device 4 or the system 2.

The resource dependent devices are grouped based on each class of device (COD) or device type. In one example, the quick connection system 20 may group same or similar Bluetooth devices based on their classes. In another example, the user may change the COD group configuration via the quick connection system 20.

In FIGS. 1-2, the devices 6 and 8 are in the same COD group, and the devices 10a and 10b are in another COD group. The devices 6 and 8 may have the same COD (or device type) or similar CODs (or device types). The device 6 and the device 10a may have the same COD or similar CODs; however, they may be classified in different COD groups. For example, the device 6 may be a “color printer” and the device 8 is a “black and white” printer, and are classified in the same COD group. Alternatively, the device 6 may be a “color printer” and the device 10a may be a “black and white” printer, and are classified in the different groups.

It is well appreciated by one of ordinary skill in the art that the group configuration is not limited to those of FIGS. 1-2. The number of resource-dependent devices with the same COD group is not limited to a specific number, and is changeable.

The quick connection system 20 includes an initial setup module 22 for initially setting-up available resource-dependent devices, and a selector 24 for selecting or making a specific resource-dependent device active after the setup procedure. The user requests a connection by selecting a resource dependent device from the selector 24. The selector 24 then communicates this request to the system 20. The selected resource dependent device and the corresponding limited resource device complete the connection. Information required for the connection may be provided from the system 20 to the limited resource device and/or the selected resource dependent device based on the use's connection request. The system 20 manages information on the limited resource device and the (connectable/selected) resource dependent devices.

The modules 20, 22 and 24 may include user interfaces, sub-systems or combinations thereof. The user interfaces may include, but not limited to, a screen and a keyboard/keypad. The system 20 may include a frontend component for the user, and a backend component that is responsible for the details of the connection based on the information initially provided in the initial setup.

The initial setup module 22 performs configuring the devices. The initial setup details are stored in the database 18 and used to categorize the resource-dependent devices. The initial setup information is used in the selection module 24.

In the initial setup stage, a COD and one communication port/resource point are assigned to a first resource-dependent device (e.g., 6). The COD and the communication port/resource point may be assigned along with other details depending on the situation (e.g., access password/key, PIN number). The assignment may be performed manually (by the user) or automatically configured in advance based on the COD. Once the first resource-dependent device has been assigned the COD and the communication port, it will be added to the database 18.

The communication port/resource point assigned to the first resource-dependent device (e.g., 6) is automatically assigned to a second resource-dependent device (e.g., 8) with the same COD of the first resource-dependent device. For example, if the user adds another resource-dependent device with the same COD of the first resource-dependent device, the database 18 is queered and the communication port/resource point of the first resource-dependent device with the same COD is automatically assigned to the second resource-dependent device. This procedure is applied to subsequent resource-dependent device with the same COD of the first and second resource-dependent devices. In other words, the initial setup module 22 automatically groups devices based on their COD and assigns each group with one communication port/resource point.

Nevertheless, the user can manually change the initial setup via the user interface of the module 22. The manual setting includes, for example, changing the communication port/resource point of a resource-dependent device, changing the COD group or a combination thereof. An individual device may be removed from the COD group though the COD may be the same as the group. If the user changes the communication port/resource point of a resource-dependent device, that individual resource-dependent device is removed from the corresponding COD group, though the COD may be the same as the group.

The selector 24 performs selecting or making a specific resource-dependent device active so that the specific device is to be connected to the device 4. The selector 24 presents the user with an easy way of selecting a previously configured device based on a COD grouping maintained in the database 18. The user specifically selects one resource-dependent device from a COD group to make it active. This selected single device (e.g., device 10b) is now actively connected to the corresponding resource allocated to the group (e.g., port of the device 4).

The initial setup module 22 may include a definition module 26 for defining a class of device (COD) group. The module 26 may include a user interface or sub-system. The COD grouping may be defined manually (by a user) or automatically. For example, the user may differentiate between classes based on their preference (e.g., color printers, black and white printers). In this example, the module 26 allows the user to define that the color printers are in a COD group different from that of the black and white printers. The resource-dependent devices may transmit their types or their own classes to the quick connection system 20, which are automatically used as CODs and thus used for the COD groping. In the drawings, the module 26 is located in the initial setup module 22; however, the module 26 may be located separately from the initial setup module 22, and is operated separately from the initial setup stage.

The initial setup module 22 may include a locator 28 for locating resource-dependent devices that are connectable to the device 4. The locator 28 may include a user interface or sub-system. A list of available resource-dependent devices is generated manually or automatically via the locator 28. The locator 28 may implement a scan/discover process. The device 4 may transmit a request signal to find available devices via the system 2, and the available devices 6, 8, 10a and 10b may respond to the request via the system 2. The list of available resource-dependent devices may be updated when the initial setup procedure starts. In the drawings, the locator 28 is located in the initial setup module 22; however, the locator 28 may be located separately from the initial setup module 22, and is operated separately from the initial setup stage.

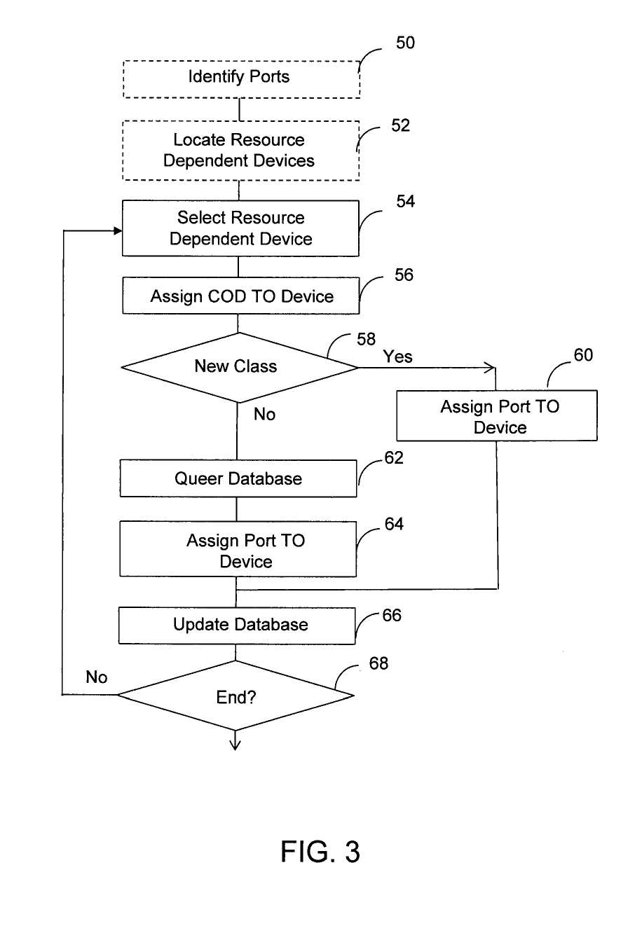

Referring to FIG. 3, there is illustrated an example of the initial setup operation performed by the quick connection system 20 of FIGS. 1-2. The user selects one of the available resource-dependent devices via the initial setup module 22 of FIGS. 1-2 (54). A COD is assigned to the selected one resource-dependent device (56). If this COD is new (58), a communication port/resource point is also assigned to the selected device (60). The database 18 is updated (66). If this COD has been already assigned to another device (68), the database 18 is queered (62) and the communication port/resource point associated to the corresponding COD group is assigned to that device (64). The database 18 is updated (66). The above steps are repeatedly performed until the end command is input by the user (68). After the initial setup, the user configures which devices are to be connected to the device 4. This is done by selecting one device for each COD group.

The procedure shown in FIG. 3 is an example only. It will be appreciated by one of ordinary skill in the art that some of the steps in FIG. 3 may be implemented manually or automatically, and any assignment may be changed manually. The initial setup process of FIG. 3 may include defining a COD group. When starting the initial setup stage, the user may define the COD group. When starting the initial setup stage, the locator 28 may identify or locate available communication ports/resource points (50), and also locates available resource-dependent devices and accesses them to obtain their information, such as the device names, types of device (52).

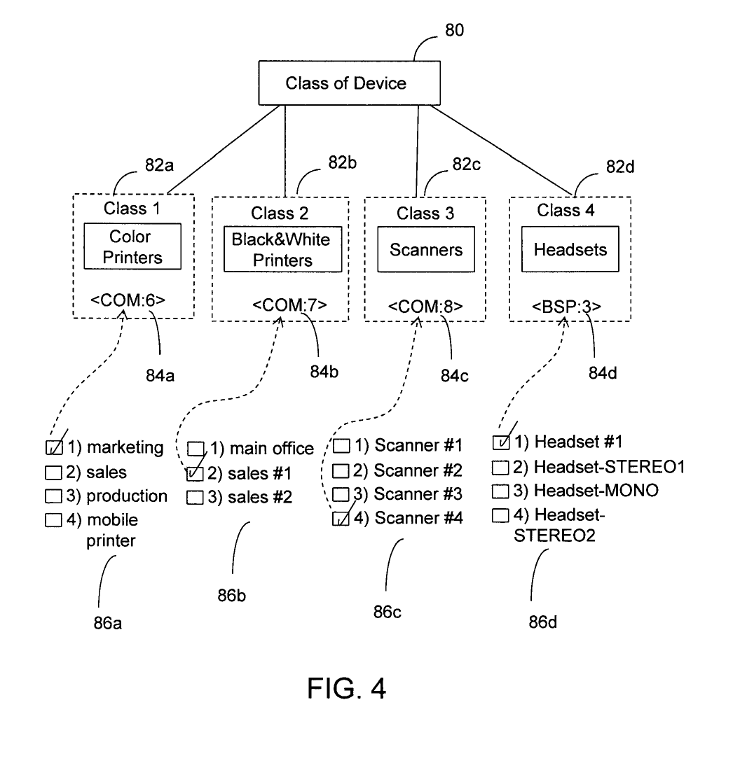

Referring to FIG. 4, there is illustrated an example of the user's defined class of device 80 and ports. In this example, the class of device 40 defines four different class groups: “Class 1” 82a; “Class 2” 82b; “Class 3” 82c; and “Class 4” 82d. The user defines that “color printers” belong to Class 1; “black and white printers” belong to Class 2; “scanners” belong to Class 3; “headsets” belong to Class 4. In the example, printers are classified into “color” and “black and white”. The definition of the COD grouping is performed by the module 26 of FIGS. 1-2.

For each class group, one port is assigned. Port 84a, shown as “<COM:6>”, is assigned to “Class 1”. Port 84b, shown as “<COM:7>”, is assigned to “Class 2”. Port 84c, shown as “<COM:8>”, is assigned to “Class 3”. Port 84d, shown as “<BSP:3>”, is assigned to “Class 4”.

As described above, the assignment of a port to a COD may be performed automatically or manually. For the manual configuration, the initial setup module 22 of FIGS. 1-2 provides to the user a list of services associated with each class, e.g., a list 86a for Class 1, a list 86b for Class 2, a list 86c for Class 3, and a list 86d for Class 4. In this example, the list 86a includes four selections: “1) marketing”; “2) sales”; “3) production”; “4) mobile printer”. If the user selects “1) marketing” for Class 1, then the module 22 automatically assigns the port 84a to Class 1. The user may manually assign/reassign another port to Class 1, among available ports. A list of the available ports is provided to the user via the module 22.

Referring to FIGS. 1-2, the quick connection system 20 for Bluetooth devices is described. In this example, the devices 4, 8, 10a, and 10b communicates with Bluetooth radio link (16, 36), and the processor 20 may have Bluetooth manager for implementing Bluetooth based communications.

The quick connection system 20 groups similar Bluetooth devices into groups based on their class. The user can configure the COD group, which includes, for example, changing the COD group of a device. The locator 28 discovers or locates Bluetooth devices with which the device 4 wants to communicate. The locator 28 generates a list of discovered devices listing the devices 6, 8, 10a and 10b. In one example, the user manually registers the Bluetooth devices into the database 18 via the locator 28. In another example, the device 4 may transmit a request signal to the system 2, and the devices 6, 8, 10a and 10b may respond to the request via the system 2. The device 4 may act as a master, and the devices 6, 8, 10a and 10b may act as slaves (in paring mode/discoverable). In a further example, the devices 6, 8, 10a and 10b may transmit a request signal to the system 2, and the device 4 may respond to the request via the system 2. The devices 6, 8, 10a and 10b may act as masters, and the device 4 may act as a slaver (in pairing mode/discoverable). In these examples, the responder may transmit device addresses and device type or name, which may be received and stored and processed at the quick connection system 20.

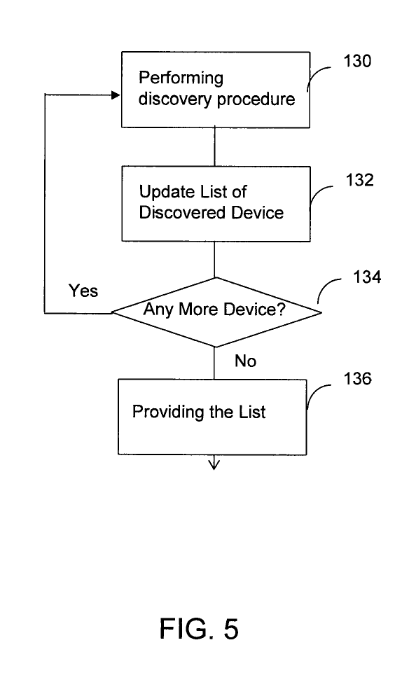

Referring to FIG. 5, there is illustrated an example of discovering/scanning procedure. A discovery procedure is performed (130) by the locator 28 of FIGS. 1-2. The locator 28 receivers a response from a device, and then adds that device into a list of discovered devices (132). If there is any further device (134), it goes to the step 130. If all devices are registered (134), it goes to the step 136. The list of the discovered device will be provided to the user (136).

The user will select, from the list of the discovered devices, a device to be paired. Once the devices are paired, the user can then connect to a single Bluetooth device for each COD group (e.g., a single headset, and/or a single scanner). Depending on the device and the Bluetooth services it offers, once the device is either paired or connected, it will attach itself to a resource.

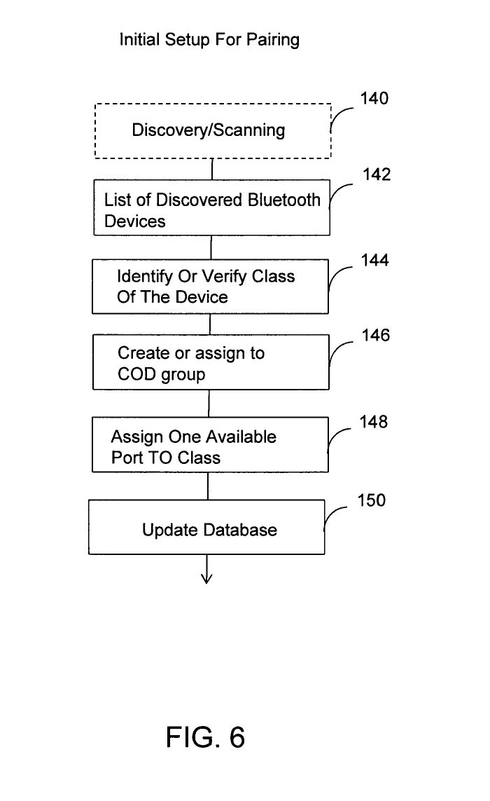

Referring to FIG. 6, there is illustrated another example of the initial setup operation for Bluetooth devices. A list of discovered Bluetooth devices is provided to the user via the quick connection system 20 of FIGS. 1-2 (142). It is asked to identify or verify the COD which they are paring (144). For example, while the user pairs a first (single or many) Bluetooth device (e.g., headset) with the mobile Bluetooth device, the user is asked to identify the COD of the first Bluetooth device based on a list of known device classes (or types) via the user interface of the initial setup module 22 of FIGS. 1-2. The initial setup module 22 may automatically set the COD based on the device type of the first Bluetooth device. Once the COD of the first Bluetooth device is identified, the COD group is created based on the predefined grouping configuration (146). For example, a headset group is created. Then it is asked to assign this group with an available port of the device 4 (148). The selected port is reserved for the headset group (150). For example, the user selects one port from a list of the available ports via the initial setup module 22. The initial setup module 22 may automatically set one available port to the headset group. The database 18 is updated.

The initial setup module 22 ensures that all subsequent headsets that are paired to the device 104 will be in the headset group and share the same port. When adding the subsequent device and identifying that that device is in the headset group, the database 18 is queered and the group configuration for the headset group is retrieved and applied to the device. Since Bluetooth typically connects to a single headset to receive audio at any one given point of time, more than one headset device in this headset group may not need to be actively connected to the port assigned to this group. However, the user is able to remove a particular headset from the headset group and assigns it a different port to that particular headset, or start another headset group using the second port, by using the quick connection system 20.

The procedure shown in FIG. 6 is an example only. It will be appreciated by one of ordinary skill in the art that some of the steps in FIG. 6 may be implemented manually or automatically, and any assignment may be changed manually. The initial setup process may include defining a COD group. When starting the initial setup stage, the user may define a COD group using the module 26. When starting the initial setup stage, the locator 28 may locate available resource-dependent devices and accesses them to obtain their information, such as the device names, types of device (150) and also identify or locate available communication ports/resource points.

Once the initial setup has occurred, the user requests a connection of the paired Bluetooth devices via the selector 24 of FIGS. 1-2. This may be done by bringing up a quick connection menu and selecting a device from a COD group. Once selected via the selector 24, the selected resource dependent Bluetooth device and the corresponding resource are connected via a connection process between the Bluetooth devices, as well understood by one of ordinary skill in the art.

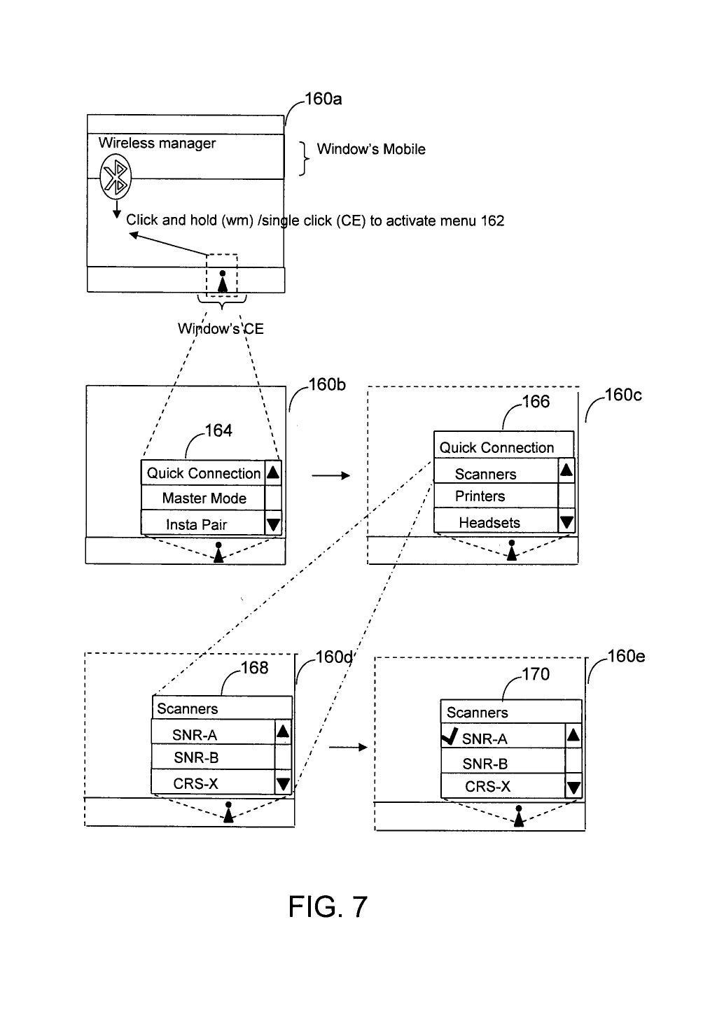

Referring to FIG. 7, there is illustrated an exemplary selection screen display provided by the selector 24 of FIGS. 1-2. When the user clicks and holds (WM) an icon (e.g., Bluetooth logo or Bluetooth icon) or single-clicks (CE) (162) on a screen (160a), a service menu 164 is provided. The user can select a service from the menu 164 (160b). When the user select “Quick Connection” from the menu 164, then quick connection menu 166 is displayed (160c). A list of COD groups are provided via the menu 166. The list on the menu 166 is based on the COD group created in the initial setup. In this example, the list includes scanners, printers and headsets. Depending on the selection of a group by the user, a group menu 168 is displayed (160d). A list of available devices on the selected group, which has been setup and configured, is displayed via the menu 168. The user selects one device to be paired from the menu (160e). In this example, the user selects “Scanner”, and then selects one scanner “SNR-A” from the Scanner group. Thus the scanner “SNR-A” is active and is available from the device (e.g., device 4 of FIGS. 1-2).

The system 2 of FIG. 1 is connectable to more than one limited resource device 4. The selector 24 of FIG. 1 may provide a menu screen to select one limited resource device from the more than one limited resource device. Once a single limited resource device is selected, the selector 24 of FIG. 1 provides the selection screen display for that single limited resource device.

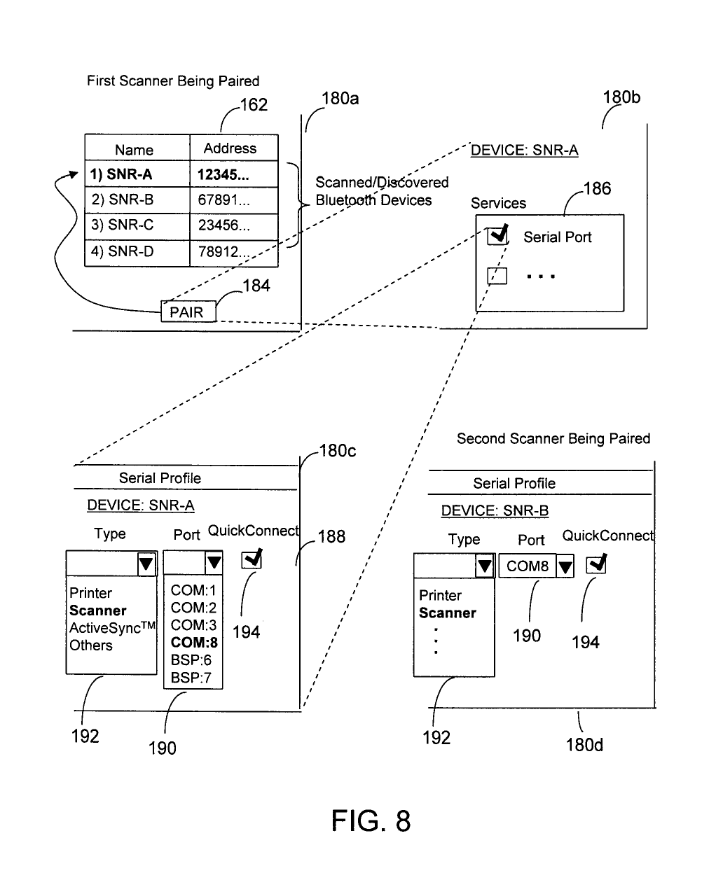

Referring to FIG. 8, there is illustrated an exemplary screen display provided by the quick connection system 20 for the initial setup. When a first scanner is to be paired, a menu 182 is displayed on a screen (180a). A list of devices, which are scanned and discovered Bluetooth devices, is shown with their addresses. The user click “PAIR” button 184 and selects one device from the menu 182. In this case, the scanner “SNR-A” is selected. Then, the device “SNR-A” data 186 including its services is displayed (180b). The displayed services include ports for the device “SNR-A”. In this example, the user selects a “serial port”. Then the serial port profile 188 for the device “SNR-A” is displayed (180c). The profile 188 shows available ports (Port) 190 and device types (Type) 192. The user select “Scanner” (Type) and “COM:8” (Port). The user also select QuickConnect option 194. The QuickConnect option 194 is used in the initial setup of a device in order to assign this device to the selector 24 (See FIG. 7).

If the user selects the device “SNR-B” from the menu 162 as a second scanner, and the user selects “Scanner” from the menu 192, the port and quick connection (the “Port” field 192 and “QuickConnect” option 194) are automatically populated based on the fact that the first scanner has enabled “QuickConnect” (180c).

According to the embodiments, the quick connection system (20 of FIGS. 1-2) solves the issue of communication ports and other resource points that may be limited in number. The quick connection system 20 also solves the issue of lengthy and cumbersome connection processes. With the quick connection system, each available device only needs to be setup/configured once. The initial setup details are stored and used to categorize the devices. Once the user is ready to use a resource dependent device (See FIG. 8), the connection process is minimized in complexity by allowing the user to simply select a limited resource device to which the user wants to connect the resource dependent device (See FIG. 7).

What is claimed is:

1. A method of sharing a resource with a plurality of resource dependent devices, comprising:
initial setting up each resource dependent device, including:
classifying a resource dependent device in group and assigning a resource associated with a limited resource device to the group; and
selecting one resource dependent device from each group to be actively connected to the corresponding resource of the limited resource device.

2. A method according to claim 1, wherein the step of the classifying and assigning comprises:
assigning a first group and a first resource to a first resource dependent device; and
automatically assigning the first resource to a second resource dependent device when the second resource dependent device is classified in the first group.

3. A method according to claim 2, wherein the step of the classifying and assigning comprises:
manually changing the assignment of the resource, the configuration of the group or a combination thereof.

4. A method according to claim 1, comprising:
Automatically assigning the group to the resource dependent device, the resource to the group or a combination thereof.

5. A method according to claim 1, comprising:
automatically configuring the group, manually configuring the group or a combination thereof.

6. A method according to claim 5, wherein the step of configuring comprises:
defining the group based on a class of device or a device type.

7. A method according to claim 5, wherein the step of configuring comprises:
manually defining the group.

8. A method according to claim 1, wherein the step of classifying and assigning comprises:
providing a list of available resource dependent devices.

9. A method according to claim 8, comprising:
locating the available resource dependent devices.

10. A method according to claim 8, comprising:
automatically generating the list, manually generating the list or a combination thereof.

11. A method according to claim 1, wherein the step of classifying and assigning comprises:
providing a list of available resources.

12. A method according to claim 1, wherein the step of selecting comprises:
providing a list of resource dependent devices that have been initial set up.

13. A system for sharing a resource with a plurality of resource dependent devices, comprising:
an initial setting up module for classifying a resource dependent device in group and assigning a resource available in a limited resource device to the group; and
a selector for selecting a single resource dependent device from each group to be actively connected to the corresponding resource of the limited resource device.

14. A system according to claim 13, wherein the selector comprises:
a user interface for allowing a user to select the single resource dependent device.

15. A system according to claim 13, comprising:
a locator for identifying the resource dependent devices connectable to the limited resource device and/or identifying one or more resources available in the limited resource device.

16. A system according to claim 13, comprising:
a locator for generating a list of resource dependent devices connectable to the limited resource device, and/or generating a list of resources available in the limited resource device.

17. A method of sharing a resource with a plurality of resource dependent devices, comprising:
selecting a group from a list of groups, each associating with one or more resource dependent devices connectable to a limited resource device and associating with a single resource available in the limited resource device; and
selecting a single resource dependent device from the selected group to actively connect the selected single resource dependent device to the corresponding single resource of the limited resource device.

18. A method according to claim 17, comprising:
deselecting the selected single resource dependent device to release the corresponding single resource.

19. A method according to claim 17, comprising:
deselecting the group to release the corresponding single resource.

20. A system of sharing a resource with a plurality of resource dependent devices, comprising:
a first selecting module for selecting a group from a list of groups, each associating with one or more resource dependent devices connectable to a limited resource device and associating with a single resource available in the limited resource device; and
a second selecting module for selecting a single resource dependent device from the selected group to actively connect the selected single resource dependent device to the corresponding single resource of the limited resource device.

21. A system according to claim 20, wherein the second selecting module includes deselecting the selected single resource dependent device to release the corresponding single resource.

22. A system according to claim 20, wherein the first selecting module includes deselecting the group to release the corresponding single resource.
